(19) United States
(12) Patent Application Publication
(10) Pub. No.: US 2019/0359209 A1
(43) Pub. Date: Nov. 28, 2019

(54) VEHICLE CONTROL DEVICE, VEHICLE CONTROL METHOD, AND VEHICLE CONTROL PROGRAM

(71) Applicant: HONDA MOTOR CO., LTD., Minato-ku, Tokyo (JP)

(72) Inventors: Akira Mizutani, Wako-shi (JP); Atsushi Ishioka, Wako-shi (JP); Akihiko Otsu, Wako-shi (JP); Daichi Kato, Wako-shi (JP); Kazuyuki Takahashi, Wako-shi (JP)

(21) Appl. No.: 16/475,400

(22) PCT Filed: Jan. 24, 2017
(86) PCT No.: PCT/JP2017/002302

§ 371 Date: Jul. 2, 2019

(51) Int. Cl. B60W 30/12; B60W 40/06; B60W 30/14; B60W 40/10; G01C 21/34

(52) U.S. Cl. CPC B60W 30/12; B60W 40/06; B60W 2050/0002; B60W 40/10; G01C 21/34; B60W 30/143

(57) ABSTRACT

A vehicle control device includes a recommended lane determiner which determines a recommended lane in which a vehicle will travel, an acquirer which acquires road information including a road shape, and an automated driving controller which causes the vehicle to travel along the recommended lane determined by the recommended lane determiner, and determines details of control of automated driving on the basis of the road information acquired by the acquirer when the recommended lane determined by the recommended lane determiner is switched from a first recommended lane to a second recommended lane.

### TECHNICAL FIELD

The present invention relates to a vehicle control device, a vehicle control method, and a storage medium.

### BACKGROUND ART

In recent years, research on autonomous vehicles which automatedly perform acceleration/deceleration and steering has been conducted. In this regard, a traveling control device for a vehicle which obtains a target trajectory of the vehicle on the basis of white lines as objects for specifying a traveling route which are included in information on a road ahead of the vehicle and performs traveling trajectory control such that the vehicle travels along the target trajectory has been disclosed. This traveling control device obtains a tentative target trajectory on the basis of white lines of a zone adjacent to a particular zone and a traveling route along which the vehicle should travel after having traveled through the particular zone, and performs tentative traveling trajectory control such that the vehicle travels along the tentative target trajectory when the vehicle is traveling in a zone where the traveling route branches into multiple traveling routes and a target trajectory cannot be obtained on the basis of the white lines, such as intersections (for example, refer to Patent Literature 1).

### CITATION LIST

### Patent Literature

[Patent Literature 1]

WO 2014/006759

### SUMMARY OF INVENTION

### Technical Problem

However, the technique disclosed in Patent Literature 1 may not allow a vehicle to smoothly travel in response to the shape of a traveling route.

An object of the present invention devised in view of the aforementioned circumstances is to provide a vehicle control device, a vehicle control method, and a vehicle control program which can allow a vehicle to travel more smoothly in response to the shape of a traveling route.

### Solution to Problem

(1): A vehicle control device 1 including: a recommended lane determiner which determines a recommended lane in which a vehicle will travel; an acquirer which acquires road information including a road shape; and an automated driving controller which causes the vehicle to travel along the recommended lane determined by the recommended lane determiner, and determines details of control of automated driving on the basis of the road information acquired by the acquirer when the recommended lane determined by the recommended lane determiner is switched from a first recommended lane to a second recommended lane.

(2): The vehicle control device according to (1), the automated driving controller determines the details of control as lane keep control for keeping a virtual lane which connects the first recommended lane and the second recommended lane and causing the vehicle to travel when the road shape is a shape of branching from a main line to a branch road.

(3): The vehicle control device according to (1), the automated driving controller determines the details of control as lane change control for changing lanes from the first recommended lane to the second recommended lane when the road shape is not a shape of branching from a main line to a branch road.

(4): The vehicle control device according to (2), the automated driving controller determines that the road shape is a shape of branching from a main line to a branch road when the road shape is a shape in which the number of lanes increases between before and after the recommended lane determined by the recommended lane determiner is switched from the first recommended lane to the second recommended lane.

(5): The vehicle control device according to (1), the automated driving controller determines that the road shape is a shape of branching from a main line to a branch road when the road shape is a shape in which the second recommended lane does not extend in front of a point at which the first recommended lane switches to the second recommended lane.

(6): A vehicle control method in which a computer determines a recommended lane in which a vehicle will travel, acquires road information including a road shape when the recommended lane is switched from a first recommended lane to a second recommended lane, and determines details of control of automated driving on the basis of the acquired road information.

(7): A computer-readable non-transitory storage medium storing a vehicle control program causing a computer: to determine a recommended lane in which a vehicle will travel; to acquire road information including a road shape when the recommended lane is switched from a first recommended lane to a second recommended lane; and to determine details of control of automated driving on the basis of the acquired road information.

### Advantageous Effects of Invention

According to (1), (6) or (7) described above, it is possible to change details of control of automated driving in response to the road shape because the details of control of automated driving are determined on the basis of the road information acquired by the acquirer when the recommended lane is switched from the first recommended lane to the second recommended lane.

According to (2) described above, it is possible to cause the vehicle to smoothly travel according to vehicle keep control when the road shape is a shape of branching from a main line to a branch road.

According to (3) described above, it is possible to change recommended lanes according to lane change control when the road shape is not a shape of branching from a main line to a branch road.

According to (4) or (5) described above, it is possible to appropriately determine whether the road shape is a shape of branching from a main line to a branch road.

### BRIEF DESCRIPTION OF DRAWINGS

FIG. 1 is a diagram showing a configuration of a vehicle system 1 including an automated driving controller.

FIG. 2 is a diagram showing a state in which a relative position and an attitude of a host vehicle M with respect to a lane L1 are recognized by a host vehicle position recognizer.

FIG. 3 is a diagram for describing an example of lane keep control;

FIG. 4 is a diagram for describing an example of lane change control;

FIG. 5 is a diagram showing a state in which a target trajectory is generated on the basis of a recommended lane.

FIG. 6 is a diagram showing recommended lanes set to a main line and a branch road.

FIG. 7 is a diagram showing an example of a state in which the host vehicle M enters a branch road from a main line according to lane keep control.

FIG. 8 is a diagram showing a comparative example of a state in which the host vehicle M enters a branch road from a main line.

FIG. 9 is a flowchart showing an example of a processing procedure performed by an action plan generator.

FIG. 10 is a diagram showing a state in which the host vehicle M travels while changing lanes according to lane change control.

### DESCRIPTION OF EMBODIMENTS

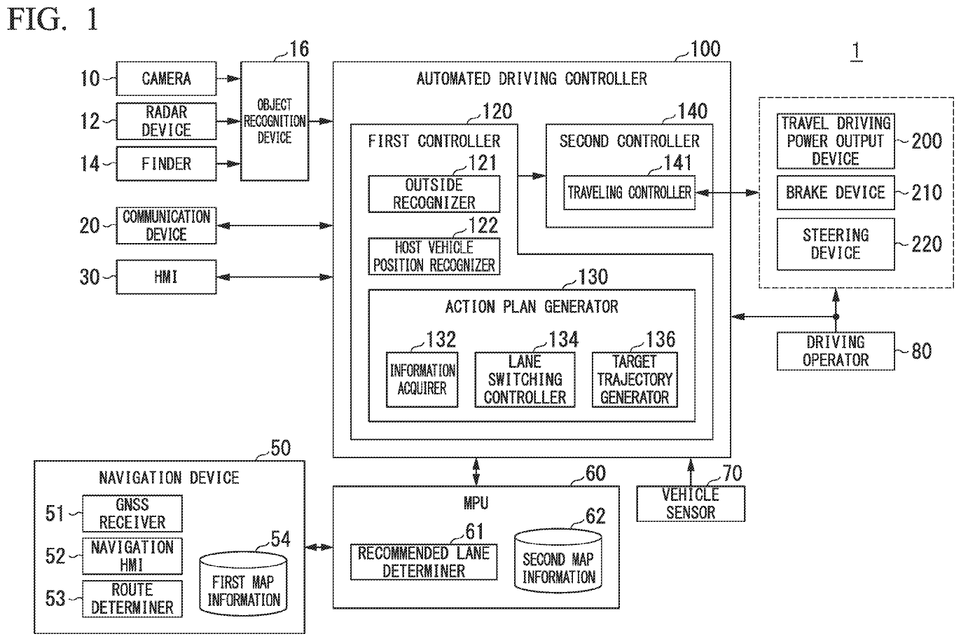

Hereinafter, embodiments of a vehicle control device, a vehicle control method, and a vehicle control program of the present invention will be described with reference to the drawings. FIG. 1 is a diagram showing a configuration of a vehicle system 1 including an automated driving controller 100. A vehicle equipped with the vehicle system 1 is a two-wheeled, three-wheeled, four-wheeled vehicle or the like, for example, and a driving source thereof includes an internal combustion engine such as a diesel engine or a gasoline engine, a motor or a combination thereof. The motor operates using power generated by a generator connected to the internal combustion engine or power discharged from a secondary battery or a fuel battery.

For example, the vehicle system 1 may include a camera 10, a radar device 12, a finder 14, an object recognition device 16, a communication device 20, a human machine interface (HMI) 30, a navigation device 50, a micro-processing unit (MPU) 60, a vehicle sensor 70, a driving operator 80, an automated driving controller 100, a travel driving power output device 200, a brake device 210, and a steering device 220. These devices and apparatuses are connected through a multiplex communication line such as a controller area network (CAN) communication line, and a serial communication line, a wireless communication network, and the like. The configuration shown in FIG. 1 is merely an example and a part of the configuration may be omitted or other components may be further added.

For example, the camera 10 may be a digital camera using a solid state imaging device such as a charge coupled device (CCD) or a complementary metal oxide semiconductor (CMOS). One or a plurality of cameras 10 are attached to any portion of a vehicle (hereinafter referred to as a host vehicle M) in which the vehicle system 1 is mounted. When a front view image is captured, the camera 10 is attached to the upper part of the front windshield, the rear side of a rear-view mirror, or the like. For example, the camera 10 may periodically repeatedly capture images of the surroundings of the host vehicle M. The camera 10 may be a stereo camera.

The radar device 12 radiates electromagnetic waves such as millimeter waves to the surroundings of the host vehicle M and detects electric waves (reflected waves) reflected by an object to detect at least the position (distance and direction) of the object. One or a plurality of radar devices 12 are attached to any portion of the host vehicle M. The radar device 12 may detect the position and speed of an object according to a frequency modulated continuous wave (FM-CW) method.

The finder 14 is a light detection and ranging (LIDAR) (or laser imaging detection and ranging) device which measures scattering light with respect to radiated light and detects a distance to a target. One or a plurality of finders 14 are attached to any portion of the host vehicle M.

The object recognition device 16 performs a sensor fusion process on detection results of some or all of the camera 10, the radar device 12 and the finder 14 to recognize the position, type, speed and the like of an object. The object recognition device 16 outputs a recognition result to the automated driving controller 100.

The communication device 20 communicates with other vehicles around the host vehicle M using a cellular network, a Wi-Fi network, Bluetooth (registered trademark), dedicated short range communication (DSRC) and the like, for example, or communicates with various server devices through a wireless base station such as VICS (registered trademark).

The HMI 30 presents various types of information to an occupant of the host vehicle M and receives an input operation from the occupant. The HMI 30 includes various display devices, speakers, buzzers, touch panels, switches, keys, etc. Operating parts such as touch panels, switches and keys in the HMI 30 serve as receivers which receive an operation of switching a driving mode of the host vehicle M to an automated driving mode. For example, the automated driving mode may be a driving mode for causing the host vehicle M to automatedly travel along a path to a destination by controlling at least one of steering and acceleration/deceleration of the host vehicle M.

The navigation device 50 may include a global navigation satellite system (GNSS) receiver 51, a navigation HMI 52 and a route search unit 53, for example, and stores first map information 54 in a storage device such as a hard disk drive (HDD) or a flash memory. The GNSS receiver 51 identifies the position of the host vehicle M on the basis of signals received from GNSS satellites. The position of the host vehicle M may be identified or complemented by an inertial navigation system (INS) using the output of the vehicle sensor 70.

The navigation HMI 52 includes a display device, a speaker, a touch panel, keys, etc. A part or all of the navigation HMI 52 and the aforementioned HMI 30 may be made to be common. The navigation HMI 52 receives information such as a destination on the basis of an operation of an occupant.

The route search unit 53 determines a route to a destination input by an occupant using the navigation HMI 52 from the position of the host vehicle M identified by the GNSS receiver 51 (or any input position) with reference to the first map information 54, for example. The route search unit 53 recalculates the route when the current position of the host vehicle M deviates from the searched route by a predetermined distance or longer. The route determined by the route search unit 53 is output to the MPU 60. In addition, the navigation device 50 may perform route guidance using the navigation HMI 52 on the basis of the route determined by the route search unit 53.

The first map information 54 is information representing road shapes according to links indicating roads and nodes connected by links, for example. The first map information 54 may include the curvatures of roads, point-of-interest (POI) information, and the like.

Further, the navigation device 50 may be realized by functions of a terminal device such as a smartphone or a tablet terminal possessed by an occupant, for example. In addition, the navigation device 50 may transmit a current position and a destination to a navigation server through the communication device 20 and acquire a route returned from the navigation server.

The MPU 60 serves as a recommended lane determiner 61, for example, and stores second map information 62 in a storage device such as an HDD or a flash memory. The recommended lane determiner 61 divides a route provided from the navigation device 50 into a plurality of blocks (divides the route into intervals of 100 m in a vehicle traveling direction, for example) and determines a recommended lane for each block with reference to the second map information 62. The recommended lane determiner 61 performs determination on which lane from the left the vehicle will travel. When a route includes a branch point, a merging point, or the like, the recommended lane determiner 61 determines recommended lanes such that the host vehicle M can travel on a reasonable traveling route for traveling to a branch destination.

The second map information 62 is map information with higher-accuracy than the first map information 54 in the navigation device 50. For example, the second map information 62 may include information on the centers of lanes or information on the boundaries of lanes. In addition, the second map information 62 may include road information, traffic regulations information, address information (addresses and zip codes), facility information, telephone number information, etc. Road information includes information representing types of roads such as a highway, a toll road, a national highway and a prefectural road and information such as the number of lanes of roads, the width of each lane, slopes of roads, locations of roads (three-dimensional coordinates including longitudes, latitudes and heights), curvatures of curves of lanes, the positions of merging points and branch points of lanes, and signs provided on roads. Further, road information includes shapes of roads at points where a recommended lane is switched. A point at which recommended lanes are switched is a position at which a main line is connected to branch roads, for example. In addition, a point at which recommended lanes are switched includes a point at which a main line is connected to a road parallel to the main line. The second map information 62 may be updated at any time by accessing other devices using the communication device 20.

The vehicle sensor 70 includes a vehicle speed sensor that detects the speed of the host vehicle M, an acceleration sensor that detects an acceleration, a yaw rate sensor that detects an angular velocity around a vertical axis, a heading sensor that detects the direction of the host vehicle M, etc.

The driving operator 80 includes an accelerator pedal, a brake pedal, a shift lever, a steering wheel, and other operators, for example. A sensor that detects an operation amount or presence or absence of an operation is attached to the driving operator 80 and a detection result thereof is output to the automated driving controller 100 or some or all of the travel driving power output device 200, the brake device 210 and the steering device 220.

The automated driving controller 100 includes a first controller 120 and a second controller 140, for example. The first controller 120 and the second controller 140 are realized by processors such as central processing units (CPUs) executing programs (software). Some or all of functional units of the first controller 120 and the second controller 140 which will be described below may be realized by hardware such as a large scale integration (LSI) circuit, an application specific integrated circuit (ASIC), and a field-programmable gate array (FPGA) or realized by software and hardware in cooperation.

For example, the first controller 120 may include an outside recognizer 121, a host vehicle position recognizer 122, and an action plan generator 130.

The outside recognizer 121 recognizes states such as the position, speed and acceleration of a neighboring vehicle on the basis of information input from the camera 10, the radar device 12 and the finder 14 through the object recognition device 16. The position of the neighboring vehicle may be represented as a representative point on the neighboring vehicle, such as the center of gravity or a corner of the neighboring vehicle, or may be represented as a region defined as the outline of the neighboring vehicle. “States” of a neighboring vehicle may include the acceleration and jerk of the neighboring vehicle or an “action state” (e.g., whether lane change is being performed or is intended to be performed). In addition, the outside recognizer 121 may recognize positions of guardrails, electricity poles, parked vehicles, pedestrians and other objects in addition to a neighboring vehicle.

The host vehicle position recognizer 122 recognizes a lane in which the host vehicle M is traveling and a relative position and an attitude of the host vehicle M with respect to the lane, for example. For example, the host vehicle position recognizer 122 may recognize a lane by comparing a lane marking pattern (e.g., arrangement of solid lines and dashed lines) obtained from the second map information 62 with a lane marking pattern around the host vehicle M recognized from an image captured by the camera 10. In such recognition, the position of the host vehicle M acquired from the navigation device 50 and a processing result of the INS may be additionally taken into account.

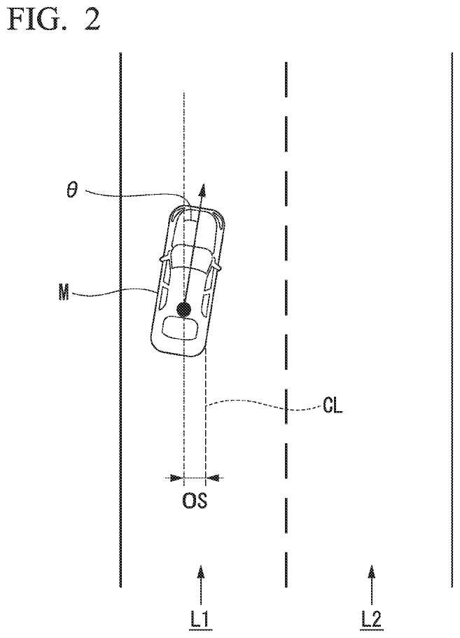

The host vehicle position recognizer 122 recognizes a relative position and attitude of the host vehicle M with respect to a lane, for example. FIG. 2 is a diagram showing a state in which a relative position and attitude of the host vehicle M with respect to a lane L1 are recognized by the host vehicle position recognizer 122. For example, the host vehicle position recognizer 122 may recognize a distance OS between a reference point (e.g., the center of gravity) of the host vehicle M and a lane center CL and an angle between a traveling direction of the host vehicle M and a line connecting the lane center CL as a relative position and attitude of the host vehicle M with respect to a lane L1. Instead of this, the host vehicle position recognizer 122 may recognize the position of the reference point of the host vehicle M or the like with respect to any side edge of the host lane L1 as a relative position of the host vehicle M with respect to the lane. The relative position of the host vehicle M recognized by the host vehicle position recognizer 122 is provided to the recommended lane determiner 61 and the action plan generator 130.

The action plan generator 130 includes an information acquirer 132, a lane switching controller 134, and a target trajectory generator 136. The action plan generator 130 determines events sequentially executed in automated driving such that the host vehicle M travels along recommended lanes determined by the recommended lane determiner 61 and surrounding situations of the host vehicle M can be handled. For example, events may include a constant-speed travel event of traveling along the same lane at a constant speed, a following travel event of following a preceding vehicle, a lane change event, a merging event, a branch event, an emergency stop event, a handover event for ending automated driving and switching automated driving to manual driving, and the like. Further, there is a case in which an action for avoidance is planned on the basis of surrounding situations of the host vehicle M (presence of neighboring vehicles or pedestrians, narrowing of lanes due to road construction, and the like) during execution of the aforementioned events.

The information acquirer 132 acquires road information corresponding to a point at which recommended lanes are switched. The lane switching controller 134 determines details of control of automated driving on the basis of road information when recommended lanes are switched. Specifically, the lane switching controller 134 determines details of control as lane keep control or lane change control on the basis of road information when recommended lanes are switched.

The target trajectory generator 136 generates a target trajectory along which the host vehicle M will travel in the future. The target trajectory is represented as a sequential arrangement of points (trajectory points) at which the host vehicle M will arrive. A trajectory point is a point at which the host vehicle M will arrive for each predetermined traveling distance, and a target speed and a target acceleration for each predetermined sampling time (e.g., approximately every several tens of a second [sec]) are generated as a part of a target trajectory apart from trajectory points. Further, a trajectory point may be a position at which the host vehicle M will arrive at a sampling time for each predetermined sampling time. In this case, information on a target speed and a target acceleration are represented by a spacing between trajectory points.

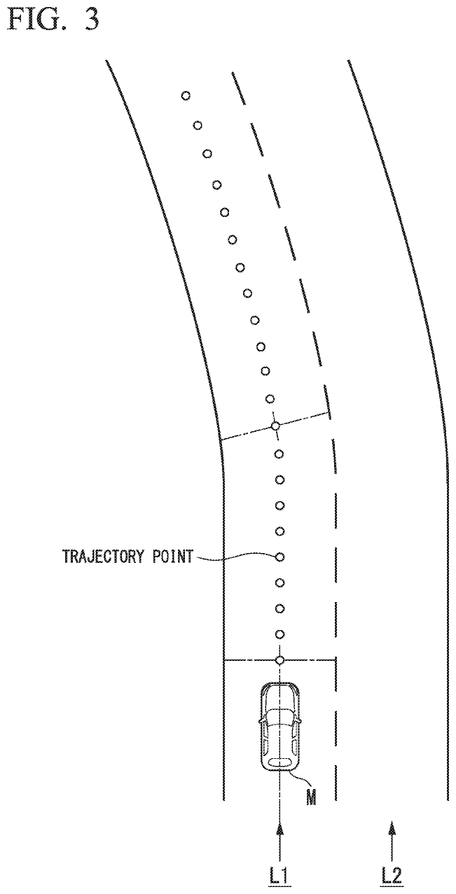

The automated driving controller 100 performs automated driving of the host vehicle M by executing control including lane keep control and lane change control. FIG. 3 is a diagram for describing an example of lane keep control. The target trajectory generator 136 sets trajectory points at the center position in the width direction of a recommended lane L1 when the host vehicle M travels along the recommended lane L1. Accordingly, the target trajectory generator 136 generates a target trajectory on the basis of the center position in the width direction of the recommended lane. Further, the target trajectory generator 136 may generate a target trajectory on the basis of the positions of both edges of the recommended lane in the width direction. The automated driving controller 100 controls traveling of the host vehicle M such that the set trajectory points are consistent with a predetermined position (a position of the center of gravity or a center position in the width direction) of the host vehicle M. Accordingly, the automated driving controller 100 performs automated driving while maintaining the position of the host vehicle M within the recommended lane. Such control corresponds to lane keep control.

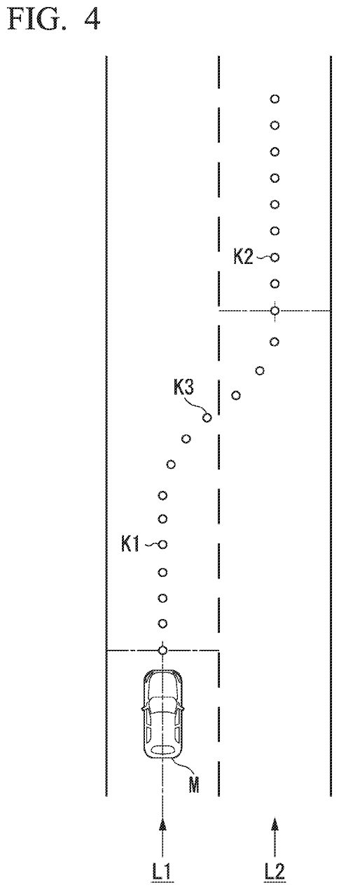

FIG. 4 is a diagram for describing an example of lane change control. The automated driving controller 100 executes lane change control when the lane L1 is changed to a neighboring lane L2. The target trajectory generator 136 sets trajectory points K1 at the center position in the width direction in the lane L1, sets trajectory points K2 at the center position in the width direction in the lane change destination L2 and further sets trajectory points K3 on a curve that smoothly connects the trajectory points K1 and the trajectory points K2. Here, the target trajectory generator 136 adjusts points at which the trajectory points K1 and K2 are set and an angle of the curve that connects the trajectory points K1 and K2 to a traveling direction on the basis of presence or absence and positions of neighboring vehicles such as a preceding vehicle with respect to the host vehicle M in the lane L1, a preceding vehicle with respect to the host vehicle M in L2, and a following vehicle. The target trajectory generator 136 adjusts the points at which the trajectory points K1 and K2 are set in the traveling direction and adjusts the angle of the curve that connects the trajectory points K1 and K2 with respect to the traveling direction such that the host vehicle M avoids neighboring vehicles. The target trajectory generator 136 calculates a straight line or a curve that smoothly connects the trajectory points K1 and the trajectory points K2 using a spline function, for example. Accordingly, the target trajectory generator 136 generates a target trajectory on the basis of presence or absence and positions of neighboring vehicles, a center position of L1 in the width direction, a center position of L2 in the width direction, and a curve that smoothly connects K1 and K2. Further, the target trajectory generator 136 may generate a target trajectory on the basis of presence or absence and positions of neighboring vehicles, positions of both edges of L1 in the width direction, positions of both edges of L2 in the width direction, and a curve that smoothly connects K1 and K2. The automated driving controller 100 controls traveling of the host vehicle M such that the set trajectory points are consistent with a predetermined position of the host vehicle M. Accordingly, the automated driving controller 100 performs automated driving to change lanes of the host vehicle M from L1 to L2. Such control corresponds to lane change control.

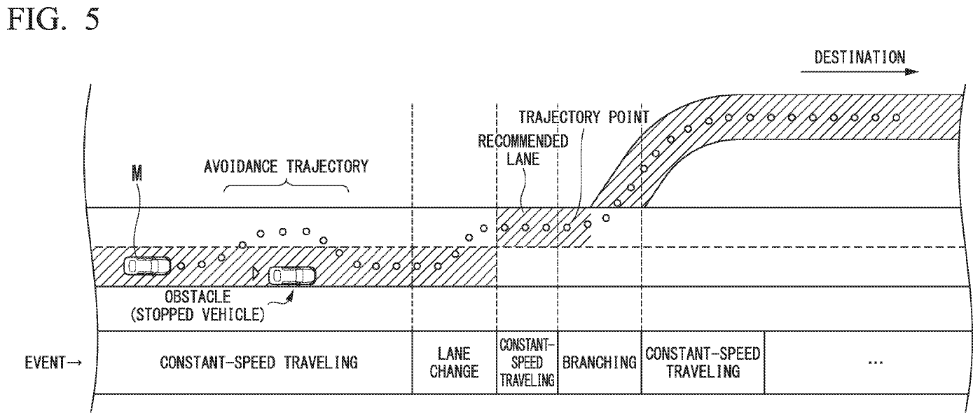

FIG. 5 is a diagram showing a state in which a target trajectory is generated on the basis of a recommended lane. As shown, a recommended lane is set such that traveling along a route to a destination is convenient. The action plan generator 130 starts a lane change event, a branching event, a merging event, a tollgate passing event or the like when the host vehicle M has approached to a predetermined distance (which may be determined according to event type) before a switching point of the recommended lane. When it is necessary to avoid an obstacle during execution of each event, an avoidance trajectory is generated as shown. The target trajectory generator 136 generates a target trajectory on the basis of standards corresponding to details of selected control, for example. The target trajectory generator 136 may change the generated target trajectory to a most suitable target trajectory at that time on the basis of viewpoint of stability and efficiency. In this manner, the host vehicle M travels along a route to a destination in the automated driving mode.

The second controller 140 includes a traveling controller 141. The traveling controller 141 controls the travel driving power output device 200, the brake device 210 and the steering device 220 such that the host vehicle M passes along a target trajectory generated by the action plan generator 130 at scheduled times.

The travel driving power output device 200 outputs a travel driving power (torque) for traveling of a vehicle to driving wheels. For example, the travel driving power output device 200 may include a combination of an internal combustion engine, a motor, a transmission and the like, and an electronic controller (ECU) which controls these components. The ECU controls the aforementioned components according to information input from the traveling controller 141 or information input from the driving operator 80.

The brake device 210 includes a brake caliper, a cylinder which transfers a hydraulic pressure to the brake caliper, an electric motor which generates a hydraulic pressure in the cylinder, and a brake ECU, for example. The brake ECU controls the electric motor according to information input from the traveling controller 141 such that a brake torque according to a braking operation is output to each vehicle wheel. The brake device 210 may include a mechanism for transferring a hydraulic pressure generated by an operation of the brake pedal included in the driving operator 80 to the cylinder through a master cylinder as a backup. Meanwhile, the brake device 210 is not limited to the above-described configuration and may be an electronically controlled hydraulic brake device which controls an actuator according to information input from the traveling controller 141 and transfers a hydraulic pressure of a master cylinder to a cylinder.

The steering device 220 includes a steering ECU and an electric motor, for example. For example, the electric motor may change the direction of the steering wheel by applying a force to a rack-and-pinion mechanism. The steering ECU drives the electric motor according to information input from the traveling controller 141 or information input from the driving operator 80 to change the direction of the steering wheel.

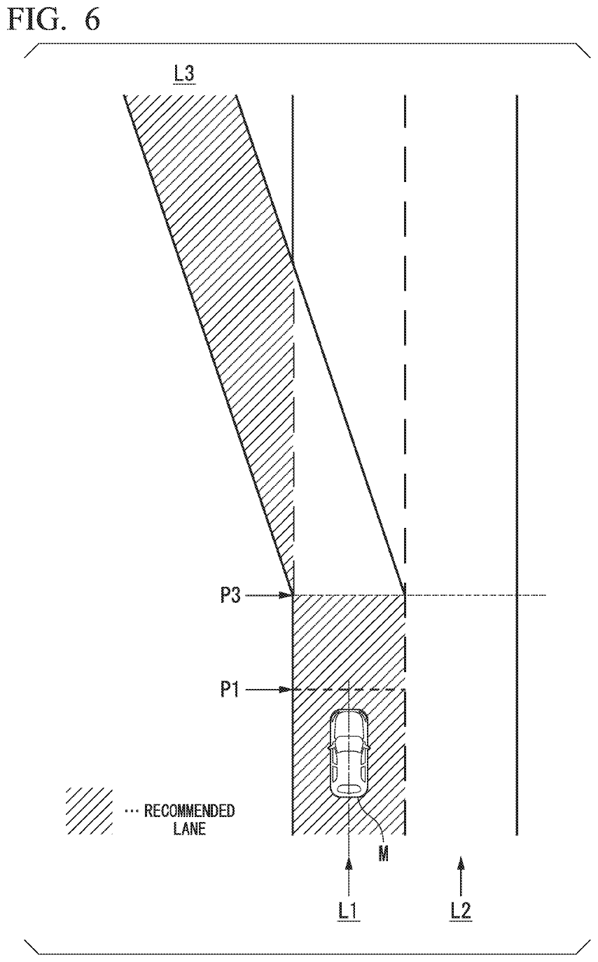

Hereinafter, a control example of selecting details of control of automated driving from details of a plurality of controls on the basis of road information when recommended lanes determined by the recommended lane determiner 61 are switched will be described. FIG. 6 is a diagram showing recommended lanes respectively set to a main line including lanes L1 and L2 and a branch road including a lane L3. A main line refers to a traveling road including one or more lanes and branches or there is merging therewith. A branch road is a traveling road branching from a main line and a traveling road to which a vehicle can travel from a lane included in a main line. When a route along which the host vehicle M will travel from a main line including the lanes L1 and L2 to a branch road including the lane L3 is set, the recommended lane determiner 61 determines, as a recommended lane, the left lane L1 in the main line from the position of the host vehicle M to a connecting point P3 of the main line and the branch road, for example. In addition, the recommended lane determiner 61 determines the lane L3 in the branch road as a recommended lane ahead of the position at which the main line and the branch road are connected.

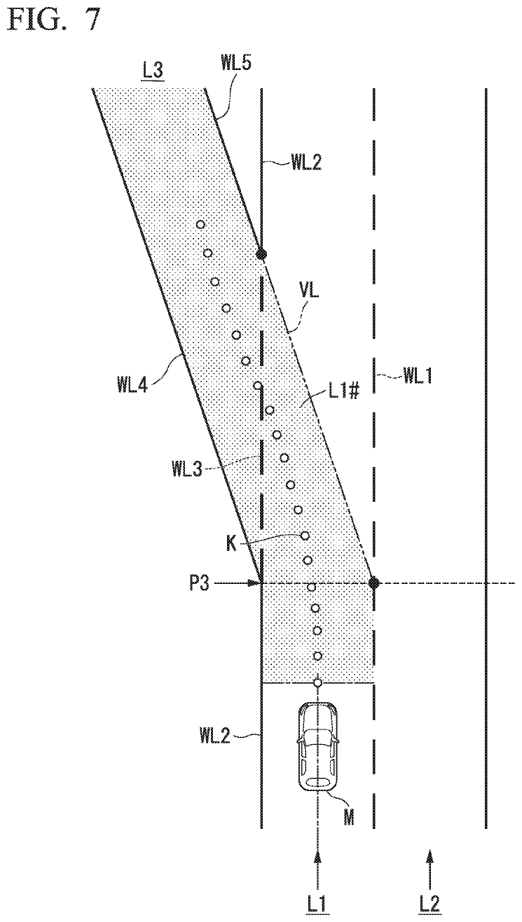

FIG. 7 is a diagram showing an example of a state in which the host vehicle M enters a branch road from a main line according to lane keep control. The lane switching controller 134 determines whether the road shape is a shape of branching from the main line to the branch road at the connecting point P3 on the basis of road information. The lane switching controller 134 determines that the road shape is a branching shape when the road shape is a shape in which the number of lanes increases before and after a switching point of recommended lanes (i.e., a shape in which the number of lanes is larger on the side in front than on a near side of the switching point of recommended lanes) or a shape in which a lane which has been switched to a recommended lane does not extend in front of the recommended lane switching point, for example. When the lane switching controller 134 determines that the road shape is a shape of branching from the main line to the branch road at the connecting point P3, the lane switching controller 134 sets a virtual lane L1# connecting the main line to the branch road and causes the host vehicle M to travel along the set virtual lane L1# according to lane keep control. Accordingly, the lane switching controller 134 causes the host vehicle M to enter the lane L3 on the branch road from the lane L1 on the main line.

The lane switching controller 134 sets the virtual lane L1# connecting from the main line to the branch road on the basis of a virtual line VL that connects lane markings (WL1 and WL2 of FIG. 7) drawn to correspond to the lane L1 on the main line and lane markings W4 and W5 drawn on the lane L3 on the branch road, for example.

Then, the target trajectory generator 136 generates a target trajectory on the basis of a line connecting center positions of the virtual lane L1# in the road width direction. Accordingly, the automated driving controller 100 can perform automated driving while maintaining the position of the host vehicle M within the virtual lane L1#. In addition, the automated driving controller 100 can start steering angle control of the host vehicle M from the vicinity of the point P3 at which the virtual line VL intersects the central lane marking WL1.

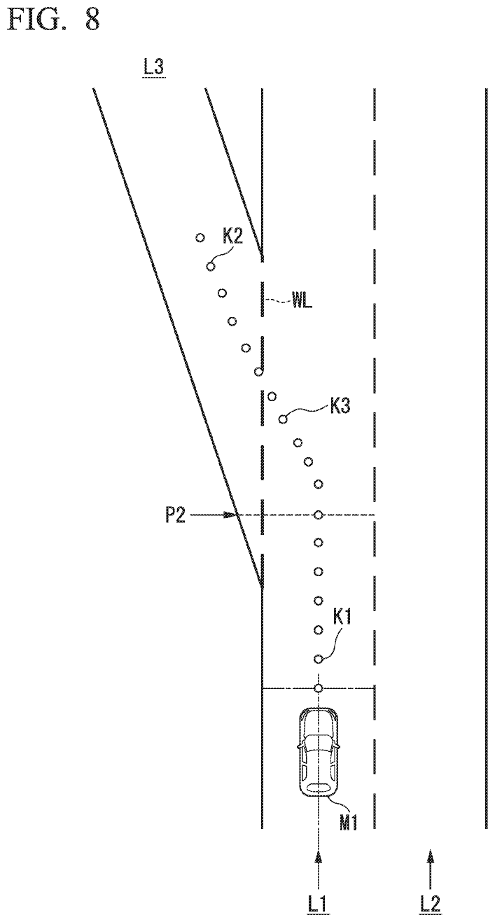

A comparative example with respect to entry of the host vehicle M into the branch road from the main line according to lane keep control will be described. FIG. 8 is a diagram showing a state in which a vehicle M1 of the comparative example enters the lane L3 on the branch road from the lane L1 on the main line. The vehicle M1 of the comparative example is a vehicle that does not have the function of setting a virtual lane to perform lane keep control when recommended lanes are switched and has the same functions as those of the host vehicle M of the embodiment with respect to other functions. In this case, the lane switching controller 134 of the vehicle M1 handles the lane L1 and the lane L3 as different lanes and performs lane change. The target trajectory generator 136 sets trajectory points K1 at the center position of the lane L1 in the width direction, sets trajectory points K2 at the center position of the lane L3 in the width direction and further sets trajectory points K3 on a curve that smoothly connects the trajectory points K1 and the trajectory points K2. Accordingly, the automated driving controller 100 performs automated driving for changing the position of the vehicle M1 from the lane L1 to the lane L3 by starting steering angle control of the vehicle M1 from a point P2. In this comparative example, the vehicle M1 needs to perform checking of preceding and following vehicles (particularly following vehicles) in a branch road, which was not originally necessary, increasing a control load. Furthermore, fine steering angle control is likely to be performed and a lateral-direction acceleration of the vehicle M1 is likely to temporarily increase compared to a case in which lane keep control is performed.

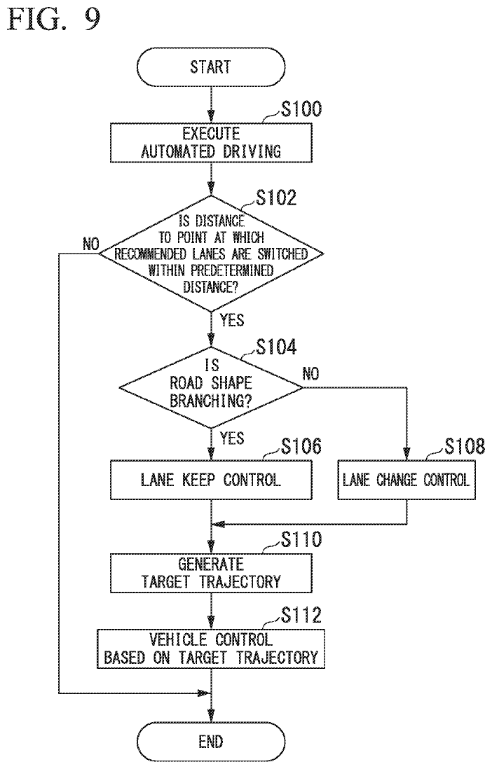

Hereinafter, a flow of control described with reference to FIGS. 6 and 7 will be described. FIG. 9 is a flowchart showing an example of a processing procedure performed by the action plan generator 130. The lane switching controller 134 determines whether a distance to a point at which recommended lanes are switched is within a predetermined distance (step S102) in the middle of execution of automated driving (step S100). When the distance to the point at which recommended lanes are switched is not within the predetermined distance, the lane switching controller 134 ends the process of this flowchart. When the distance to the point at which recommended lanes are switched is within the predetermined distance, the lane switching controller 134 determines whether the road shape of the point at which recommended lanes are switched is a shape of branching from a main line to a branch road (step S104).

When the road shape of the point at which recommended lanes are switched is a shape of branching from a main line to a branch road, the lane switching controller 134 determines that the host vehicle M will be caused to travel according to lane keep control (step S106). When the road shape of the point at which recommended lanes are switched is not a shape of branching from a main line to a branch road, the lane switching controller 134 determines that the host vehicle M is caused to travel according to lane change control (step S108). Next, the target trajectory generator 136 generates a target trajectory (step S110). Subsequently, the automated driving controller 100 performs vehicle control on the basis of the generated target trajectory (step S112).

As described above, the vehicle system 1 can select lane keep control as control of automated driving for entering a branch road from a main line when the road shape at a point at which recommended lanes are switched is a shape of branching from the main line to the branch road.

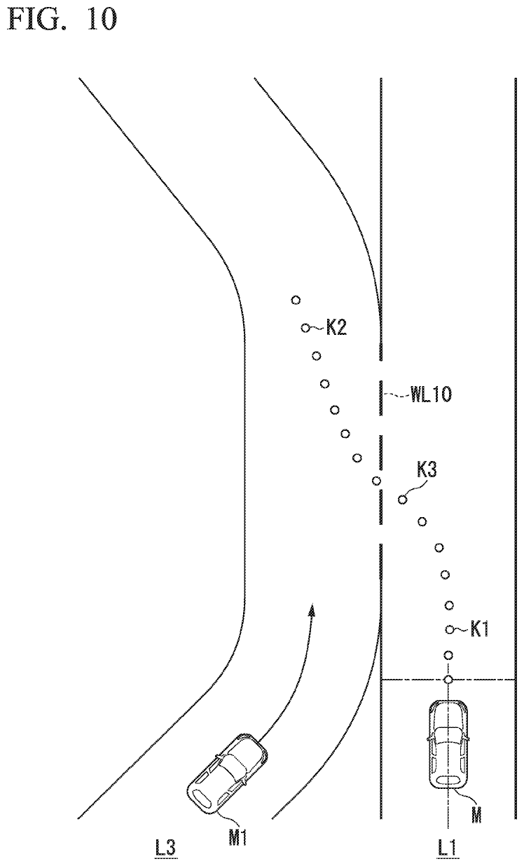

Hereinafter, a case in which a road shape is not a shape of branching from a main line to a branch road when recommended lanes are switched will be described. FIG. 10 is a diagram showing a state in which the host vehicle M travels while switching lanes according to lane change control. When the lane switching controller 134 determines that the road shape is not a shape of branching from the main line to the branch road on the basis of acquired road information, the lane switching controller 134 causes the host vehicle M to travel according to lane change control. As described above, the lane switching controller 134 determines that the road shape is a branching shape when the road shape is a shape in which the number of lanes increases before and after a point at which recommended lanes are switched or a lane that has been switched to a recommended lane does not extend to the front of the recommended lane switching point. In the road shape shown in FIG. 10, the number of lanes does not increase before and after the point at which recommended lanes are switched and the lane that has been switched to a recommended lane extends to the front of the recommended lane switching point. Accordingly, the lane switching controller 134 determines that the road shape is not a shape of branching from the main line to the branch road and causes the host vehicle M to travel according to lane change control.

In the case of following recommended lane switching according to lane change control, the target trajectory generator 136 sets trajectory points K1 at the center position of the lane L1 on the main line in the road width direction, sets trajectory points K2 at the center position of the lane L3 on a traveling road that meets the main line and then separates therefrom in the road width direction and further sets trajectory points K3 on a curve that connects the trajectory points K1 and the trajectory points K2. In addition, the target trajectory generator 136 may adjust spacings of the trajectory points and the positions of the trajectory points on the basis of the relationship between the position of the host vehicle M and the position of another vehicle M1. The automated driving controller 100 causes the host vehicle M to travel along the target trajectory such that the host vehicle M passes through a boundary line WL10 from the lane L1 on the main line and enters the lane L3.

As described above, the vehicle system 1 can select lane change control as control of automated driving for entering a branch road from a main line when a road shape is not a shape of branching from the main line to the branch road. Accordingly, it is possible to reduce a control load and prevent occurrence of an unnecessary lateral acceleration. Furthermore, a timing at which the host vehicle M starts steering control may be advanced.

Meanwhile, although a case in which the vehicle system 1 selects and executes one of lane change control and lane keep control has been described as an example of changing details of control of automated driving at a switching point of recommended lanes, the present invention is not limited thereto. The vehicle system 1 may switch details of control such that a vehicle speed when a road shape is a shape of branching from a main line to a branch road at a switching point of recommended lanes becomes higher than a vehicle speed in other cases. Accordingly, the vehicle system 1 can switch between passing through a switching point of recommended lanes at a high speed and passing through the switching point at a low speed safely depending on a road shape.

As described above, according to the vehicle system 1, it is possible to cause the host vehicle M to travel more smoothly depending on road shapes because recommended lanes in which the host vehicle M will travel are determined, road information including road shapes is acquired when recommended lanes are switched, and details of control of automated driving are determined on the basis of the acquired road information.

Furthermore, according to the vehicle system 1, since lane change control is executed when a road shape is not a shape of branching from a main line to a branch road, it is possible to realize traveling that prioritizes stability depending on road shapes.

While forms for embodying the present invention have been described using embodiments, the present invention is not limited to these embodiments and various modifications and substitutions can be made without departing from the spirit or scope of the present invention.

What is claim is:

1. A vehicle control device comprising:
a recommended lane determiner configured to determine a recommended lane in which a vehicle will travel;
an acquirer configured to acquire road information including a road shape; and
an automated driving controller configured to cause the vehicle to travel along the recommended lane determined by the recommended lane determiner, and to determine details of control of automated driving on the basis of the road information acquired by the acquirer when the recommended lane determined by the recommended lane determiner is switched from a first recommended lane to a second recommended lane.

2. The vehicle control device according to claim 1,
wherein the automated driving controller is configured to determine the details of control as lane keep control for keeping a virtual lane which connects the first recommended lane and the second recommended lane and causing the vehicle to travel when the road shape is a shape of branching from a main line to a branch road.

3. The vehicle control device according to claim 1,
wherein the automated driving controller is configured to determine the details of control as lane change control for changing lanes from the first recommended lane to the second recommended lane when the road shape is not a shape of branching from a main line to a branch road.

4. The vehicle control device according to claim 2,
wherein the automated driving controller is configured to determine that the road shape is a shape of branching from a main line to a branch road when the road shape is a shape in which the number of lanes increases between before and after the recommended lane determined by the recommended lane determiner is switched from the first recommended lane to the second recommended lane.

5. The vehicle control device according to claim 2,
wherein the automated driving controller is configured to determine that the road shape is a shape of branching from a main line to a branch road when the road shape is a shape in which the recommended lane determined by the recommended lane determiner does not extend in front of a point at which the recommended lane is switched from the first recommended lane to the second recommended lane.

6. A vehicle control method comprising, using a computer:
determining a recommended lane in which a vehicle will travel;
acquiring road information including a road shape when the recommended lane is switched from a first recommended lane to a second recommended lane; and
determining details of control of automated driving on the basis of the acquired road information.

7. A computer-readable non-transitory storage medium storing a vehicle control program causing a computer:
to determine a recommended lane in which a vehicle will travel;
to acquire road information including a road shape when the recommended lane is switched from a first recommended lane to a second recommended lane; and
to determine details of control of automated driving on the basis of the acquired road information.
